(19) United States
(12) Patent Application Publication
(10) Pub. No.: US 2018/0262716 A1
(43) Pub. Date: Sep. 13, 2018

(54) METHOD OF PROVIDING VIDEO CONFERENCE SERVICE AND APPARATUSES PERFORMING THE SAME

(71) Applicant: ELECTRONICS AND TELECOMMUNICATIONS RESEARCH INSTITUTE, Daejeon (KR)

(72) Inventors: Jin Ah KANG, Daejeon (KR); Hyunjin YOON, Daejeon (KR); Deockgu JEE, Daejeon (KR); Jong Hyun JANG, Sejong (KR); Mi Kyong HAN, Daejeon (KR)

(21) Appl. No.: 15/917,313

(22) Filed: Mar. 9, 2018

(30) Foreign Application Priority Data
Mar. 10, 2017 (KR) 10-2017-0030782

(51) Int. Cl. H04N 7/15; G06K 9/00; G10L 25/03; H04N 19/136

(52) U.S. Cl. CPC H04N 7/152; H04N 19/136; G10L 25/03; G06K 9/00268

(57) ABSTRACT

Provided are a method of providing a video conference service and apparatuses performing the same, the method including determining contributions of a plurality of participants to a video conference based on first video signals and first audio signals of devices of the plurality of participants participating in the video conference, and generating a second video signal and a second audio signal to be transmitted to the devices of the plurality of participants based on the contributions.

### CROSS-REFERENCE TO RELATED APPLICATION(S)

This application claims the priority benefit of Korean Patent Application No. 10-2017-0030782 filed on Mar. 10, 2017, in the Korean Intellectual Property Office, the disclosure of which is incorporated herein by reference for all purposes.

### BACKGROUND

### 1. Field

One or more example embodiments relate to a method of providing a video conference service and apparatuses performing the same.

### 2. Description of Related Art

A next generation video conference service enables conference participants at different locations to feel like they are in the same space.

Video and audio qualities greatly affect on an reality effect. Thus, the video and audio qualities are ultra-high definition (UHD) and super wideband (SWB) classes.

Recently, the video conference service is also applied to a service for a large number of participants, for example, remote education. Terminals of the conference participants transmit ultra-high quality video and audio data to a video conference server. The video conference server processes and mixes the video and audio data, and transmits the mixed data to the terminals of the conference participants.

### SUMMARY

An aspect provides technology that determines contributions of a plurality of participants to a video conference using video signals and audio signals of the plurality of participants participating in the video conference, and generates a video signal and an audio signal to be transmitted to the plurality of participants based on the contributions.

Another aspect also provides video conference technology that provides different mixing orders, arrangements, or mixing sizes of video signals and audio signals based on contributions of participants participating in a video conference, thereby increasing immersion and realism that the participants experience.

According to an aspect, there is provided a method of providing a video conference service, the method including determining contributions of a plurality of participants to a video conference based on first video signals and first audio signals of devices of the plurality of participants participating in the video conference, and generating a second video signal and a second audio signal to be transmitted to the devices of the plurality of participants based on the contributions.

The determining may include analyzing the first video signals and the first audio signals, estimating feature values of the first video signals and the first audio signals, and determining the distributions based on the feature values.

The analyzing may include extracting and decoding bitstreams of the first video signals and the first audio signals.

The feature values of the first video signals may include at least one of the number of faces, sizes of the faces, positions of the faces, gazes of the faces, and mouth shapes of the faces.

The feature values of the first audio signals may include at least one of whether a sound is present, a loudness of the sound, and a duration of the sound.

The generating may include generating the second video signal and the second audio signal by mixing the first video signals and the first audio signals.

The generating may further include determining at least one of a mixing quality and a mixing scheme with respect to the first video signals and the first audio signals based on the contributions.

The mixing scheme with respect to the first video signals may control at least one of an image arrangement order and an image arrangement size.

The mixing scheme with respect to the first audio signals may control at least one of whether to block a sound and a volume level.

The generating may further include encoding and packetizing the second video signal and the second audio signal.

According to another aspect, there is also provided an apparatus for providing a video conference service, the apparatus including a transceiver configured to receive first video signals and first audio signals of devices of a plurality of participants participating in a video conference, and a controller configured to determine contributions of the plurality of participants to the video conference based on the first video signals and the first audio signals, and generate a second video signal and a second audio signal to be transmitted to the devices of the plurality of participants based on the contributions.

The controller may include an analyzer configured to analyze the first video signals and the first audio signals, and estimate feature values of the first video signals and the first audio signals, and a determiner configured to determine the distributions based on the feature values.

The analyzer may be configured to extract and decode bitstreams of the first video signals and the first audio signals.

The feature values of the first video signals may include at least one of the number of faces, sizes of the faces, positions of the faces, gazes of the faces, and mouth shapes of the faces.

The feature values of the first audio signals may include at least one of whether a sound is present, a loudness of the sound, and a duration of the sound.

The controller may further include a mixer configured to mix the first video signals and the second video signals, and a generator configured to generate the second video signal and the second audio signal.

The mixer may be configured to determine at least one of a mixing quality and a mixing scheme with respect to the first video signals and the first audio signals based on the contributions.

The mixing scheme with respect to the first video signals may control at least one of an image arrangement order and an image arrangement size.

The mixing scheme with respect to the first audio signals may control at least one of whether to block a sound and a volume level.

The generator may be configured to encode and packetize the second video signal and the second audio signal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a video conference service providing system according to an example embodiment;

FIG. 2 is a block diagram illustrating a video conference service providing apparatus of FIG. 1;

FIG. 3 is a block diagram illustrating a controller of FIG. 2;

FIGS. 4A through 4C illustrate examples of screen compositions of participant devices of FIG. 1;

FIG. 5 illustrates an example of operations of an analyzer and a determiner of FIG. 3;

FIG. 6A is a flowchart illustrating operations of a video analyzer and the determiner of FIG. 3;

FIG. 6B illustrates examples of video signals;

FIG. 6C illustrates examples of an operation of the video analyzer of FIG. 3;

FIG. 6D illustrates other examples of the operation of the video analyzer of FIG. 3;

FIG. 6E illustrates examples of the operation of the determiner of FIG. 3;

FIG. 7A is a flowchart illustrating operations of an audio analyzer and the determiner of FIG. 3;

FIG. 7B illustrates examples of audio signals;

FIG. 7C illustrates examples of the operation of the audio analyzer of FIG. 3;

FIG. 7D illustrates examples of the operation of the determiner of FIG. 3;

FIG. 8A illustrates an example of the operation of the determiner of FIG. 3;

FIG. 8B illustrates another example of the operation of the determiner of FIG. 3; and

FIG. 9 is a flowchart illustrating the video conference service providing apparatus of FIG. 1.

### DETAILED DESCRIPTION

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, reference will now be made in detail to the example embodiments, examples of which are illustrated in the accompanying drawings, wherein like reference numerals refer to the like elements throughout.

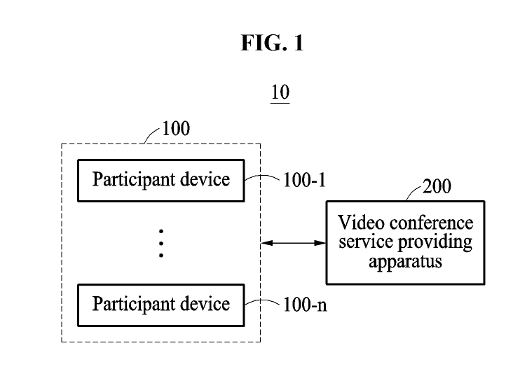

FIG. 1 is a block diagram illustrating a video conference service system according to an example embodiment.

Referring to FIG. 1, a video conference service system 10 may include a plurality of participant devices 100, and a video conference service providing apparatus 200.

The plurality of participant devices 100 may communicate with the video conference service providing apparatus 200. The plurality of participant devices 100 may receive a video conference service from the video conference service providing apparatus 200. For example, the video conference service may include all services related to a video conference.

The plurality of participant devices 100 may include a first participant device 100-1 through an n-th participant device 100-n. For example, n may be a natural number greater than or equal to “1”.

The plurality of participant devices 100 may each be implemented as an electronic device. For example, the electronic device may be implemented as a personal computer (PC), a data server, or a portable device.

The portable electronic device may be implemented as a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an electronic book (e-book) or a smart device. The smart device may be implemented as a smart watch or a smart band.

The plurality of participant devices 100 may transmit first video signals and first audio signals to the video conference service providing apparatus 200. For example, the first video signals may include video data generated by capturing participants participating in a video conference using the plurality of participant devices 100. The first audio signals may include audio data of sounds transmitted by the participants in the video conference.

The video conference service providing apparatus 200 may generate a second video signal and a second audio signal to be transmitted to the plurality of participant devices 100 based on the first video signals and the first audio signals of the plurality of participant devices 100. The video conference service providing apparatus 200 may be implemented as a video conference multipoint control unit (MCU).

For example, the video conference service providing apparatus 200 may determine contributions of a plurality of participants participating in the video conference to the video conference using the plurality of participant devices 100 based on the first video signals and the first audio signals. Then, the video conference service providing apparatus 200 may generate the second video signal and the second audio signal based on the determined contributions. The second video signal and the second audio signal may include video and/or audio data with respect to at least one of the plurality of participants participating in the video conference.

In detail, the video conference service providing apparatus 200 may generate the second video signal and the second audio signal such that information of a participant device currently performing a significant role in the video conference and thus having a relatively high contribution may be clearly transmitted and video and/or audio data of a participant of the participant device may be clearly shown. Further, the video conference service providing apparatus 200 may generate the second video signal and the second audio signal by excluding video and/or audio data of a participant currently leaving the video conference or not actually participating in the video conference and thus having a relatively low contribution.

Hence, the video conference service providing apparatus 200 may provide the plurality of participant devices 100 with a video conference service that may increase immersion in the video conference.

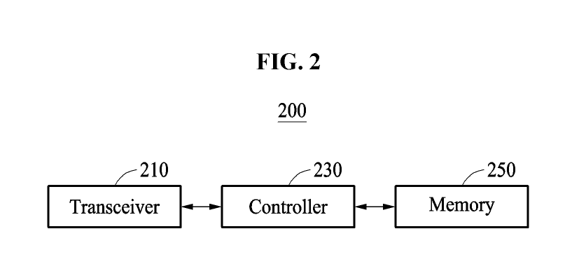

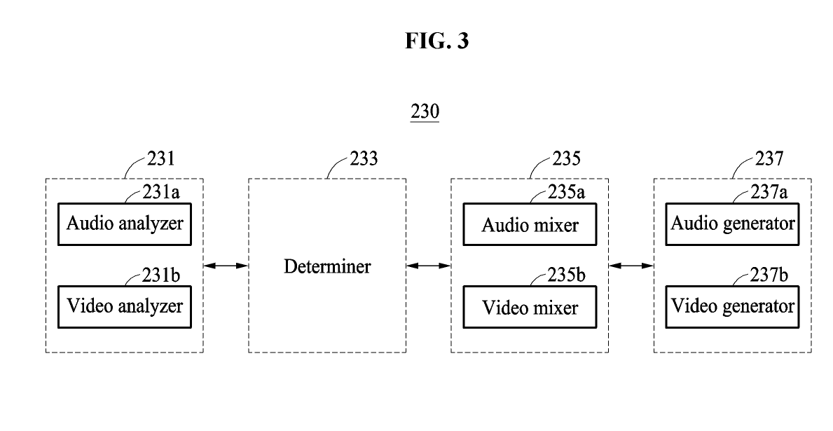

FIG. 2 is a block diagram illustrating the video conference service providing apparatus of FIG. 1, and FIG. 3 is a block diagram illustrating a controller of FIG. 2.

Referring to FIGS. 2 and 3, the video conference service providing apparatus 200 may include a transceiver 210, a controller 230, and a memory 250.

The transceiver 210 may communicate with the plurality of participant devices 100. For example, the transceiver 210 may communicate with the plurality of participant devices 100 based on various communication protocols such as Orthogonal Frequency Division Multiple Access (OFDMA), Single Carrier Frequency Division Multiple Access (SC-FDMA), Generalized Frequency Division Multiplexing (GFDM), Universal Filtered Multi-Carrier (UFMC), Filter Bank Multicarrier (FBMC), Biorthogonal Frequency Division Multiplexing (BFDM), Non-Orthogonal multiple access (NOMA), Code Division Multiple Access (CDMA), and Internet Of Things (IOT).

The transceiver 210 may receive first video signals and first audio signals transmitted from the plurality of participant devices 100. In this example, the first video signals and the first audio signals may be video signals and audio signals that are encoded and packetized.

The transceiver 210 may transmit a video signal and an audio signal to the plurality of participant devices 100. In this example, the video signal and the audio signal may be a second video signal and a second audio signal generated by the controller 230.

The controller 230 may control an overall operation of the video conference service providing apparatus 200. For example, the controller 230 may control operations of the other elements, for example, the transceiver 210 and the memory 250.

The controller 230 may obtain the first video signals and the first audio signals received through the transceiver 210. In this example, the controller 230 may store the first video signals and the first audio signals in the memory 250.

The controller 230 may determine contributions of the plurality of participant devices 100. For example, the controller 230 may determine the contributions of the plurality of participant devices 100 to a video conference based on the first video signals and the first audio signals of the plurality of participant devices 100. In this example, the plurality of participant devices 100 may each be a device used by a participant or a plurality of participants participating in the video conference. Further, the contributions may include at least one of conference contributions and conference participations with respect to the video conference.

The controller 230 may generate the video signal and the audio signal to be displayed in the plurality of participant devices 100. For example, the controller 230 may generate the second video signal and the second audio signal based on the contributions of the plurality of participant devices 100 to the video conference. In this example, the controller 230 may store the second video signal and the second audio signal in the memory 250.

The controller 230 may include an analyzer 231, a determiner 233, a mixer 235, and a generator 237. In this example, the analyzer 231 may include an audio analyzer 231a and a video analyzer 231b, the mixer 235 may include an audio mixer 235a and a video mixer 235b, and the generator 237 may include an audio generator 237a and a video generator 237b.

The analyzer 231 may output feature values of the first video signals and the first audio signals by analyzing the first video signals and the first audio signals. The analyzer 231 may include the audio analyzer 231a and the video analyzer 231b.

The audio analyzer 231a may decode the first audio signals by extracting bitstreams of the first audio signals.

The audio analyzer 231a may analyze feature points of the decoded first audio signals. For example, the feature points may be sound waveforms.

Further, the audio analyzer 231a may estimate the feature values of the first audio signals based on the analysis on the feature points. For example, the feature values may be at least one of whether a sound is present, a loudness of the sound, and a duration of the sound (or a speaking duration of the sound). In this example, the audio analyzer 231a may smooth the feature values.

The video analyzer 231b may decode the first video signals by extracting bitstreams of the first video signals. The video analyzer 231b may analyze feature points of the decoded first video signals. For example, the feature points may be at least one of the number of faces of the participant and the plurality of participants participating the video conference, eyebrows of the faces, eyes of the faces, pupils of the faces, noses of the faces, and lips of the faces.

Further, the video analyzer 231b may estimate the feature values of the first video signals based on the analysis on the feature points of the first video signals. For example, the feature values may be at least one of sizes of the faces of the participant and the plurality of participants participating in the video conference, positions of the faces (or, distances from a center of a screen to the faces), gazes of the faces (or, forward gaze levels of the faces), and lip shapes of the faces. In this example, the video analyzer 231b may smooth the feature values.

The determiner 233 may determine the contributions of the plurality of participant devices 100 to the video conference based on the feature values of the first video signals and the first audio signals. In this example, the feature values of the first video signals and the first audio signals may be smoothed feature values.

In an example, the determiner 233 may determine the contributions to the video conference by determining whether each of the plurality of participant devices 100 is speaking based on feature values of at least one of the first video signals and the first audio signals. The contributions may be contributions to the video conference added and/or subtracted in proportion to at least one of the feature values of the first video signals and the first audio signals.

In another example, the determiner 233 may combine the feature values of the first video signals and the first audio signals, and determine the contributions to the video conference by determining whether each of the plurality of participant devices 100 is speaking. In this example, the contributions may be contributions to the video conference added and/or subtracted in proportion to the feature values of the first video signals and the first audio signals.

The mixer 235 may mix the first video signals and the first audio signals of the plurality of participant devices 100. In this example, the mixer 235 may determine at least one of a mixing quality and a mixing scheme with respect to the first video signals and the first audio signals. The mixer 235 may include the audio mixer 235a and the video mixer 235b.

The audio mixer 235a may determine at least one of a mixing quality and a mixing scheme with respect to the first audio signals based on the contributions, and mix the first audio signals based on the determined at least one. For example, the mixing scheme with respect to the first audio signals may be a mixing scheme that controls at least one of whether to block a sound and a volume level.

The video mixer 235b may determine at least one of a mixing quality and a mixing scheme with respect to the first video signals based on the contributions, and mix the first video signals based on the determined at least one. For example, the mixing scheme with respect to the first video signals may be a mixing scheme that controls at least one of an image arrangement order and an image arrangement size.

The generator 237 may generate the second video signal and the second audio signal. The generator 237 may include the audio generator 237a and the video generator 237b.

The audio generator 237a may generate the second audio signal by encoding and packetizing the mixed first audio signals, and the video generator 237b may generate the second video signal by encoding and packetizing the mixed first video signals.

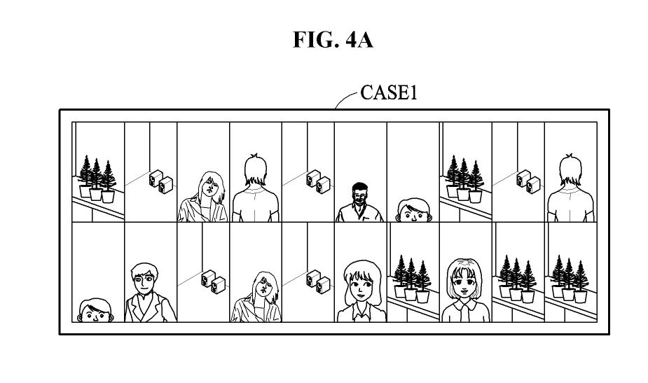

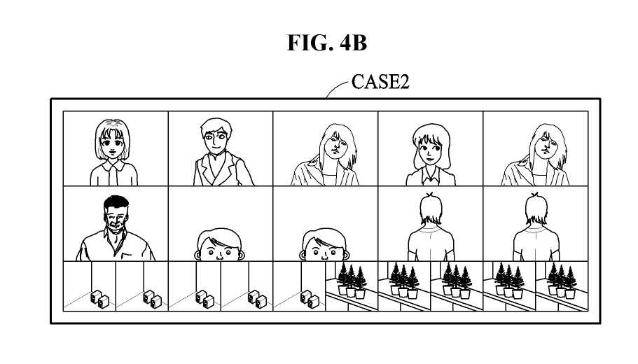

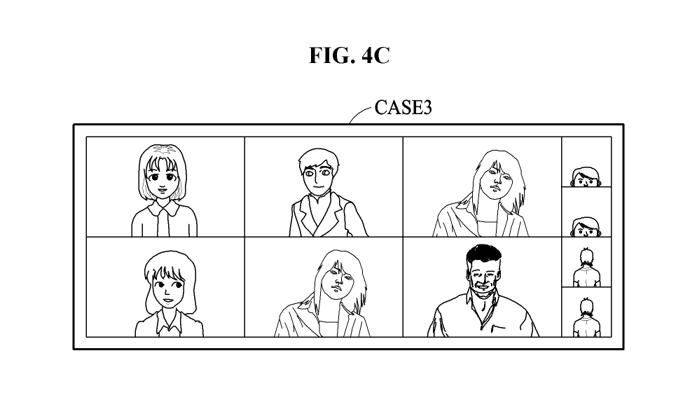

FIGS. 4A through 4C illustrate examples of screen compositions of the participant devices of FIG. 1.

In FIGS. 4A through 4C, for ease of description, it may be assumed that the number of the participant devices 100 participating in a video conference is “20”.

Referring to FIGS. 4A through 4C, screen compositions of the plurality of participant devices 100 may be as shown in CASE1, CASE2, and CASE3.

CASE1 is a screen composition of a second video signal in which first video signals of the twenty participant devices 100 are arranged on screens of the same size. Further, the screens of CASE1 are arranged based on an order in which the twenty participant devices 100 access the video conference.

CASE2 and CASE3 are each a screen composition of a second video signal in which first video signals are arranged on screens of different sizes based on contributions of the twenty participant devices 100 to a video conference.

In the screen composition of CASE2, the screen arrangement and the sizes of the screens may be determined based on the number of faces, sizes of the faces, gazes of the faces, and whether a sound is present.

In detail, in the screen composition of CASE2, ten first video signals having highest contributions to the video conference may be arranged sequentially from an upper left side to a lower right side. Further, in the screen composition of CASE2, the other ten video signals having lowest contributions to the video conference may be arranged on a bottom line.

In the screen composition of CASE3, the screen arrangement and the sizes of the screens may be determined based on the number of faces, sizes of the faces, gazes of the faces, and whether a sound is present.

In detail, in the screen composition of CASE3, only ten first video signals having highest contributions to the video conference may be arranged. In this example, in the screen composition of CASE3, six first video signals having highest contributions with respect to the gazes of the faces may be arranged on a left side, and the other four first video signals having lowest contributions may be arranged on a right side.

The screen composition of CASE3 may not include first video signals and first audio signals of a plurality of participants leaving the video conference for a predetermined time, and include first audio signals of the plurality of participant devices 100 having high contributions to the video conference with an increased volume.

Thus, through CASE3, the video conference service providing apparatus 200 may be effective to an environment in which there are a great number of participant devices 100 and a network bandwidth is insufficient.

That is, the video conference service providing apparatus 200 may provide different mixing orders, arrangements, or mixing sizes of video signals and audio signals based on contributions of participants participating in a video conference, thereby increasing immersion and realism that the plurality of participants experience.

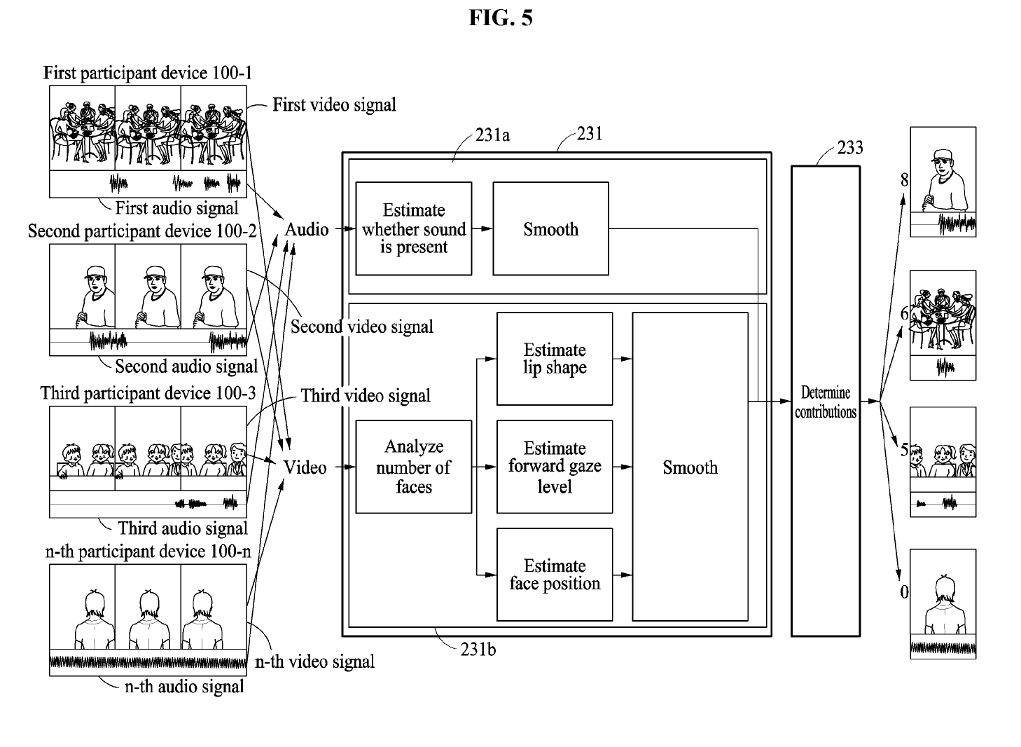

FIG. 5 illustrates an example of operations of the analyzer and the determiner of FIG. 3.

Referring to FIG. 5, the analyzer 231 may receive first video signals and first audio signals from the first participant device 100-1 through the n-th participant device 100-n, and analyze the first video signals and the first audio signals.

The audio analyzer 231a may analyze and determine feature points, for example, sound waveforms, of the first audio signals transmitted from the first participant device 100-1 through the n-th participant device 100-n. The audio analyzer 231a may estimate feature values of the first audio signals based on the analyzed and determined sound waveforms of the first audio signals. In this example, the audio analyzer 231a may smooth the estimated feature values.

The video analyzer 231b may analyze and determine feature points, for example, the number of faces of participants, of the first video signals transmitted from the first participant device 100-1 through the n-th participant device 100-n. The video analyzer 231b may estimate feature values of the first video signals based on the analyzed and determined number of the faces of the participants of the first video signals. In this example, the video analyzer 231b may smooth the estimated feature values.

The determiner 233 may determine contributions of the first participant device 100-1 through the n-th participant device 100-n to the video conference based on the feature values.

For example, the determiner 233 may determine the contributions using the feature values estimated based on the sound waveforms of the first audio signals and the feature values estimated based on the number of the faces of the first video signals. For example, the determiner 233 may determine a contribution of the first participant device 100-1 to be “6”, a contribution of a second participant device 100-2 to be “8”, a contribution of a third participant device 100-3 to be “5”, and a contribution of the n-th participant device 100-n to be “0”.

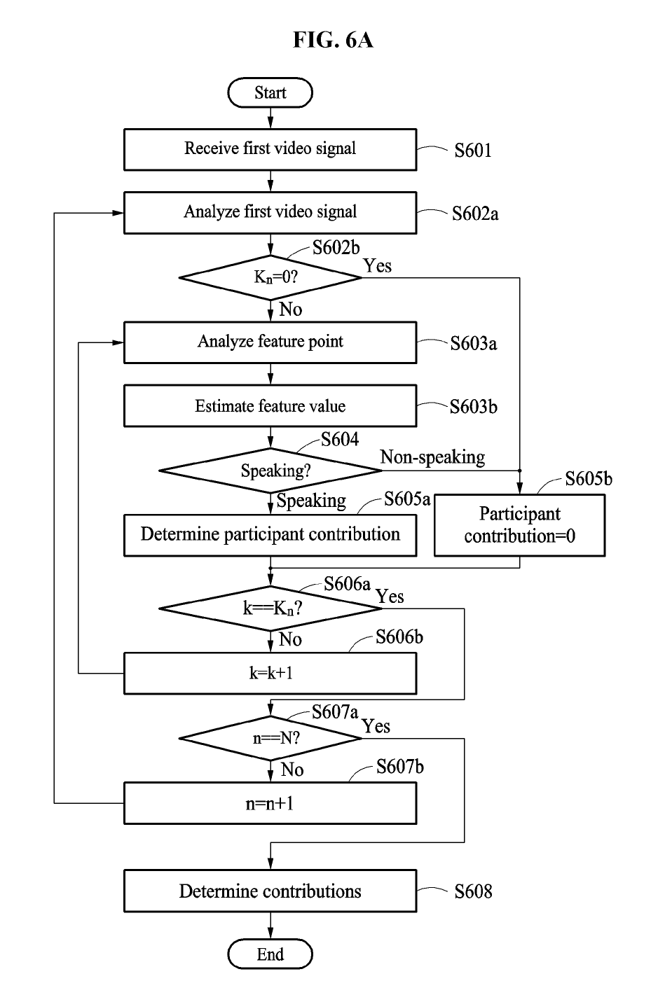

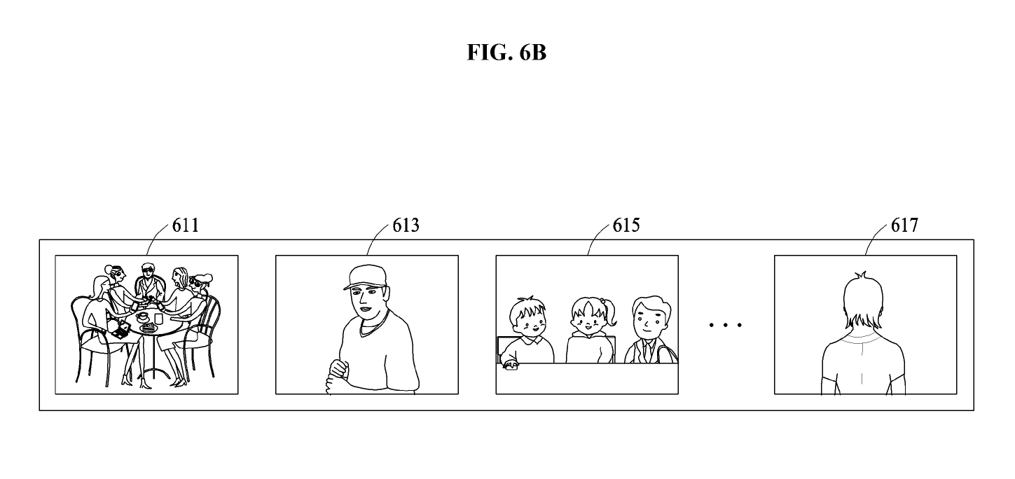

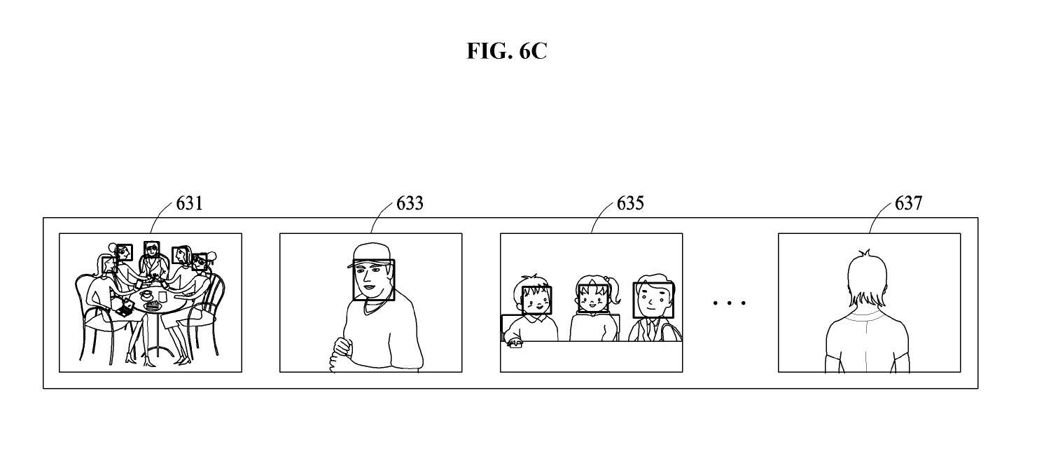

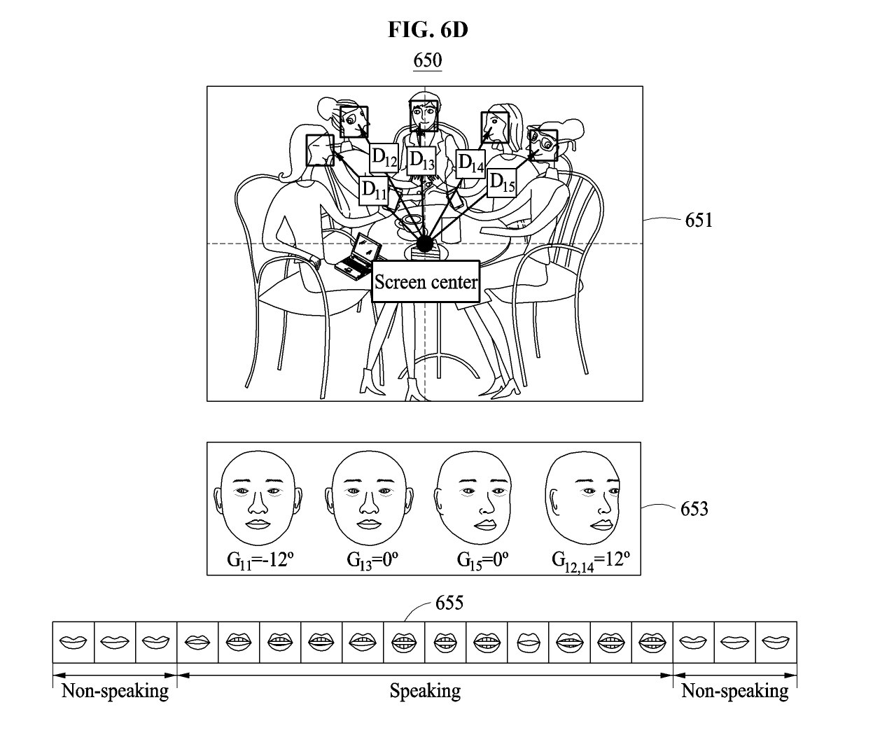

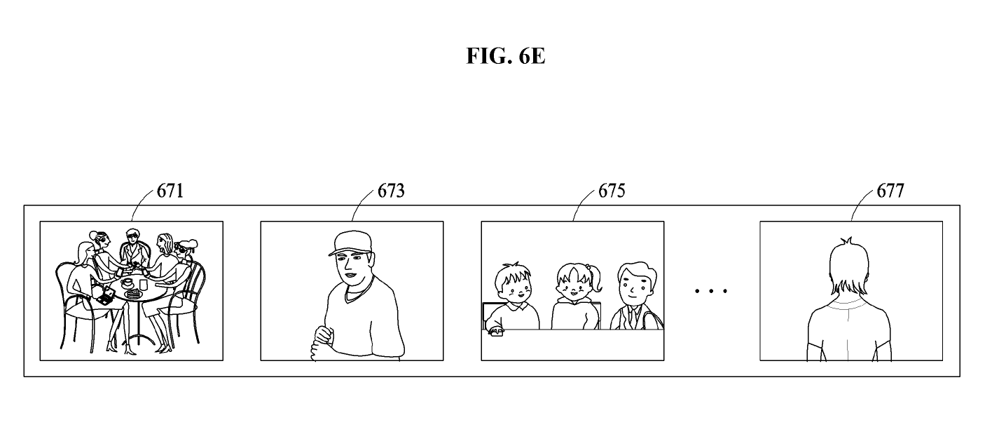

FIG. 6A is a flowchart illustrating operations of the video analyzer and the determiner of FIG. 3, FIG. 6B illustrates examples of video signals, FIG. 6C illustrates examples of an operation of the video analyzer of FIG. 3, FIG. 6D illustrates other examples of the operation of the video analyzer of FIG. 3, and FIG. 6E illustrates examples of the operation of the determiner of FIG. 3.

Referring to FIGS. 6A through 6E, in operation S601, the video analyzer 231b may receive a first video signal. The video analyzer 231b may receive a first video signal of an n-th participant device 100-n among N participant devices 100. In this example, n denotes an ordinal number of a participant device, and N denotes the number of the participant devices 100. Further, a range of n may be 0<n≤N, and n may be a natural number.

In an example of FIG. 6B, the video analyzer 231b may receive a first video signal 611 of a first participant device 100-1, a first video signal 613 of a second participant device 100-2, a first video signal 615 of a third participant device 100-3, and a first video signal 617 of the n-th participant device 100-n.

In operation S602a, the video analyzer 231b may analyze the first video signal. For example, the video analyzer 231b may analyze the first video signal of the n-th participant device 100-n, among the N participant devices 100. In this example, n may be “1” in a case of the first participant device 100-1.

In operation S602b, the video analyzer 231b may determine the number K of faces of the first video signal based on the analyzed first video signal. For example, the video analyzer 231b may determine the number Kₙ of faces of a k-th participant of the first video signal based on the analyzed first video signal of the n-th participant device 100-n. In this example, k denotes the number of participants of the first video signal of the n-th participant device 100-n. Further, a range of k may be 0<k≤K, and k may be a natural number.

In an example of FIG. 6C, the video analyzer 231b may determine the number K₁ of faces of the first video signal 611 of the first participant device 100-1 to be “5” as shown in an image 631, the number K₂ of faces of the first video signal 613 of the second participant device 100-2 to be “1” as shown in an image 633, the number K₃ of faces of the first video signal 615 of the third participant device 100-3 to be “3” as shown in 635, and the number Kₙ of faces of the first video signal 617 of the n-th participant device 100-n to be “0” as shown in an image 637.

In operation S603a, the video analyzer 231b may analyze a feature point. In this example, the feature point may include eyebrows, eyes, pupils, a nose, and lips. For example, the video analyzer 231b may analyze a feature point of a k-th participant of the first video signal of the n-th participant device 100-n. In this example, k may be “1” in a case of a first participant.

In operation S603b, the video analyzer 231b may estimate a feature value. In this example, the feature value may include a distance Dₙₖ from a center of a screen to a face of the k-th participant of the first video 617 of the n-th participant device 100-n, a forward gaze level Gₙₖ, and a lip shape Lₙₖ.

In an example, the video analyzer 231b may estimate D₁ₖ of the k-th participant of the first participant device 100-1 as shown in an image 651 of FIG. 6D. In detail, the video analyzer 231b may estimate D₁₁, D₁₂, D₁₃, D₁₄, and D₁₅ of first, second, third, fourth, and fifth participants of the first participant device 100-1.

In another example, the video analyzer 231b may estimate (^{1k} of the k-th participant of the first participant device 100-1 as shown in an image 653 of FIG. 6D. In detail, the video analyzer 231b may estimate G₁₁ of the first participant of the first participant device 100-1 to be −12 degrees, G_{12,14} of the second and fourth participants to be 12 degrees, G₁₃ of the third participant to be 0 degrees, and G₁₅ of the fifth participant to be 0 degrees.

In still another example, the video analyzer 231b may estimate L₁ₖ of the k-th participant of the first participant device 100-1 as shown in an image 655 of FIG. 6D. In detail, the video analyzer 231b may estimate L₁ₖ of the k-th participant of the first participant device 100-1 to be opened and closed.

In operation S604, the determiner 233 may determine whether a participant is speaking. For example, the determiner 233 may determine whether the k-th participant of the first video signal 611 is speaking based on a lip shape L₁ₖ of the k-th participant of the first participant device 100-1 as shown in the image 655 of FIG. 6D. In detail, the determiner 233 may determine that the k-th participant is speaking when the lip shape L₁ₖ of the k-th participant of the first video signal 611 of the first participant device 100-1 is opened, and determine that the k-th participant is not speaking when the lip shape L₁ₖ is closed.

In operation S605a, the determiner 233 may determine a contribution of the participant based on the feature values. The determiner 233 may determine a contribution Cₙₖ of the k-th participant of the n-th participant device 100-n based on Dₙₖ, Gₙₖ and Lₙₖ in response to determination that the k-participant of the first video signal is speaking. In detail, the determiner 233 may determine the contribution Cₙₖ of the k-th participant by adding Cₙₖ when Dₙₖ of the k-th participant of the n-th participant device 100-n is relatively small, when Gₙₖ is relatively close to “0”, and when the speaking duration Tₙₖ is relatively long in a case in which is opened, which indicates continuous speaking.

In operation S605b, the determiner 233 may determine the contribution of the participant to be “0”. When a participant of a first video signal is not speaking and the number K of faces of the first video signal is “0”, the determiner 233 may determine the contribution Cₙₖ of the participant of the first video signal to be “0”.

In operation S606a, the determiner 233 may determine values of k and Kₙ. That is, the determiner 233 may determine values of the ordinal number k of the participant and the number Kₙ of faces.

In operation S606b, the determiner 233 may update k to k+1=k when k is less than Kₙ.

When Kₙ of the first participant device 100-1 is “5” and k is “1”, the determiner 233 may update k to k+1=k, and perform operations S603a through S606a with respect to a second participant (k=2) of the first participant device 100-1. That is, the determiner 233 may iteratively perform operations S603a through S606a until k is equal to Thus, the determiner 233 may determine contributions of all the plurality of participants of the first participant device 100-1.

In operation S607a, the determiner 233 may compare n and N when k is equal to Kₙ That is, the determiner 233 may compare the ordinal number n of the corresponding participant device and the number N of the participant devices 100.

In operation S607b, the determiner 233 may update n to n+1=n when n is less than N. In a case in which the number N of the participant devices 100 is “20” and the ordinal number n of the corresponding participant device is “1”, the determiner 233 may update n to n+1=n, and perform operations S602a through S607a with respect to a second participant device. That is, the determiner 233 may iteratively perform operations S602a through S607a until n is equal to N. Thus, the determiner 233 may determine contributions of all the plurality of participants of the N participant devices 100.

In operation S608, when n is equal to N, the determiner 233 may determine contributions of the plurality of participant devices 100 to the video conference. For example, a contribution Cₙ of the n-th participant device 100-n among the N participant devices 100 to the video conference may be a maximum participant contribution maxₖ{Cₙₖ} of contributions of a plurality of participants of the n-th participant device 100-n. In an example of FIG. 6E, the determiner 233 may determine a contribution 671 of the first participant device 100-1 to the video conference to be “3”, a contribution 673 of the second participant device 100-2 to the video conference to be “4”, a contribution 675 of the third participant device 100-3 to the video conference to be “2”, and a contribution 677 of the n-th participant device 100-n to the video conference to be “0”.

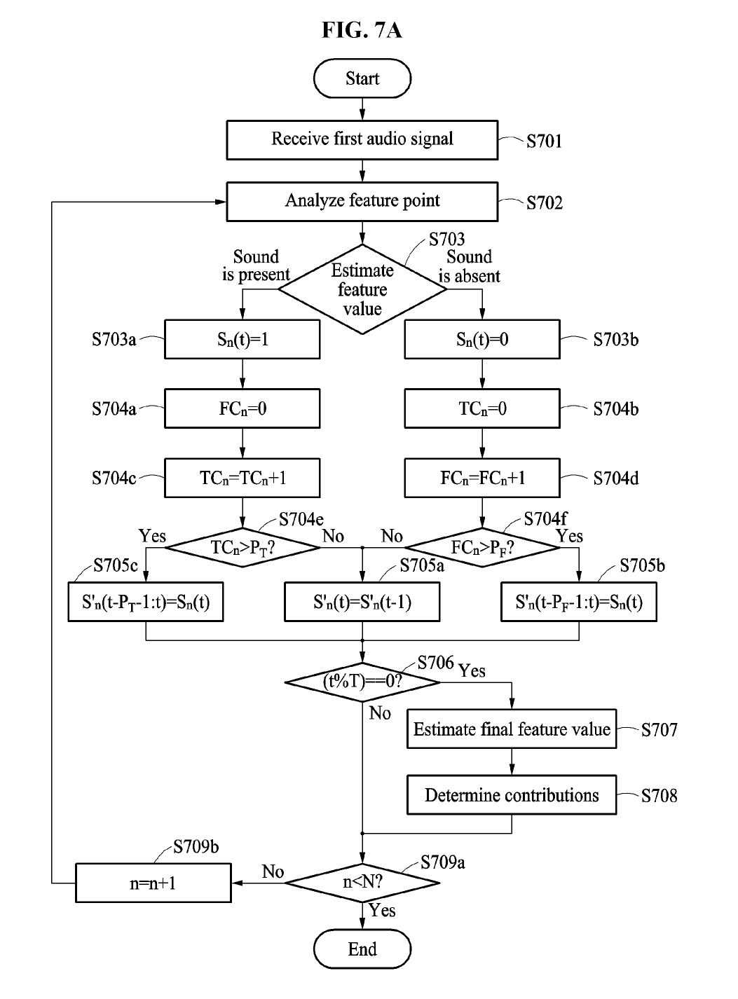

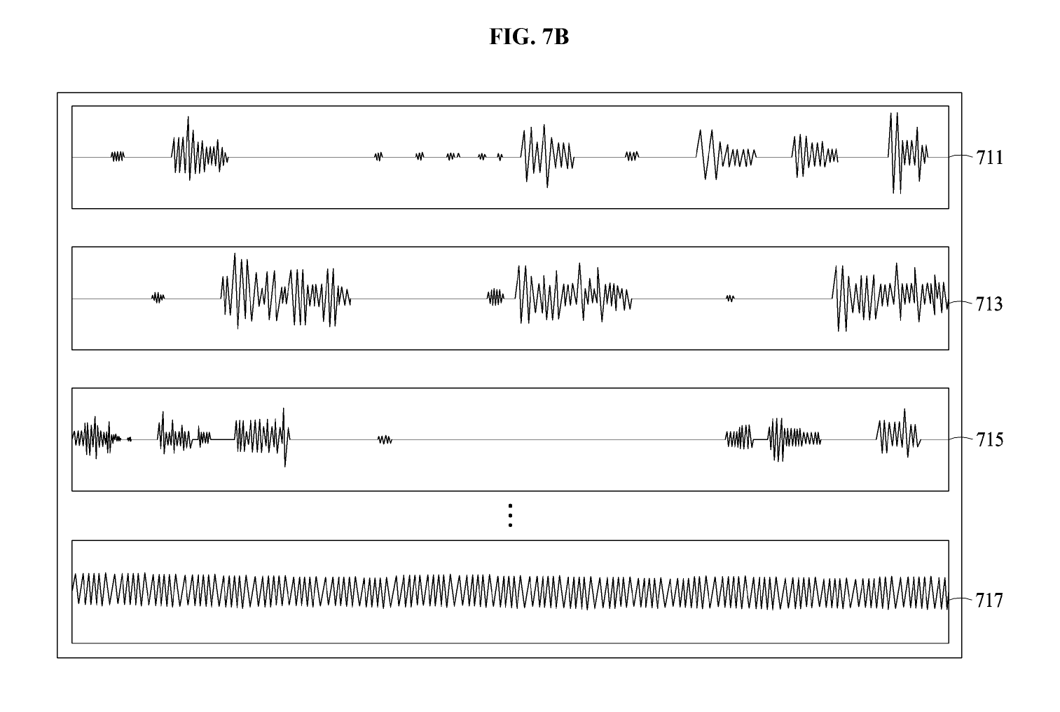

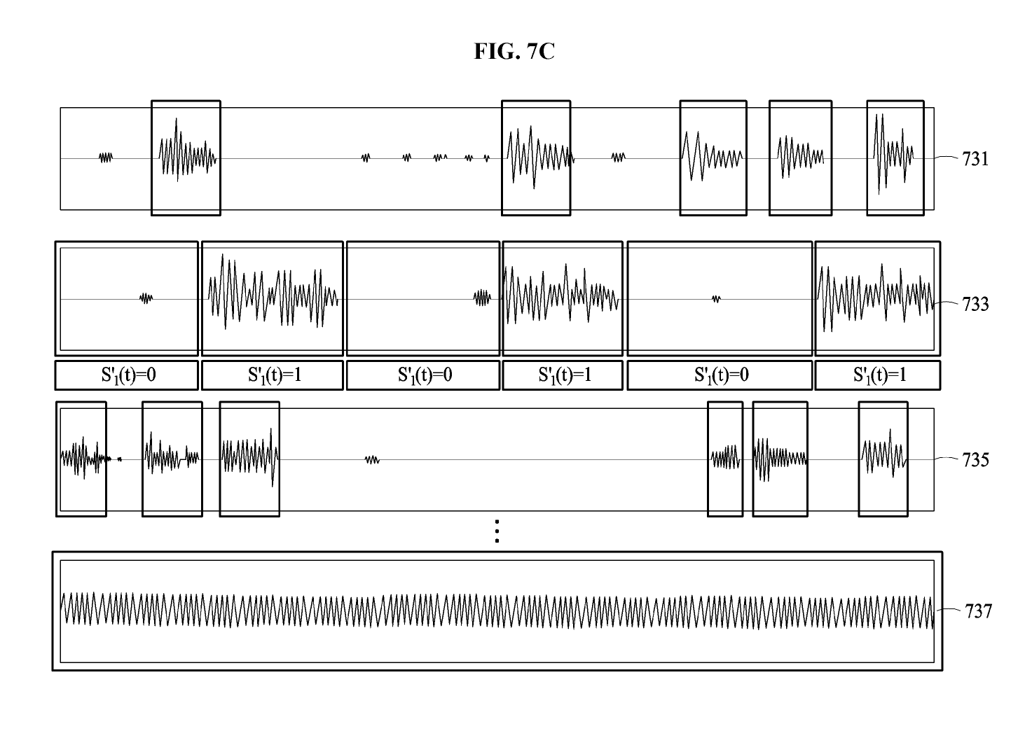

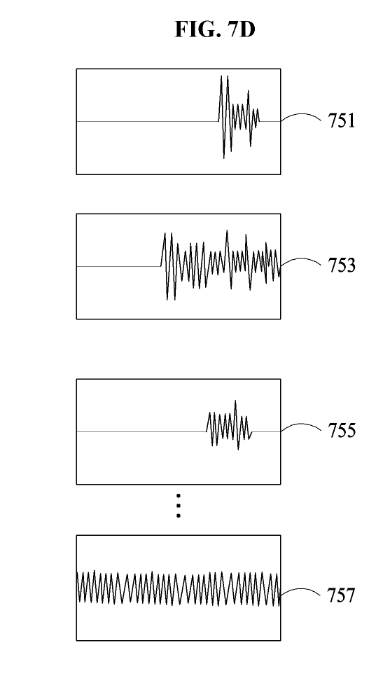

FIG. 7A is a flowchart illustrating operations of the audio analyzer and the determiner of FIG. 3, FIG. 7B illustrates examples of audio signals, FIG. 7C illustrates examples of the operation of the audio analyzer of FIG. 3, and FIG. 7D illustrates examples of the operation of the determiner of FIG. 3.

Referring to FIGS. 7A through 7D, in operation S701, the audio analyzer 231a may receive a first audio signal. The audio analyzer 231a may receive a first audio signal of an n-th participant device 100-n among N participant devices 100. In this example, n denotes an ordinal number of a participant device, and N denotes the number of the plurality of participant devices 100. Further, a range of n may be 0<n≤N, and n may be a natural number.

In an example of FIG. 7B, the audio analyzer 231a may receive a first audio signal 711 of a first participant device 100-1, a first audio signal 713 of a second participant device 100-2, a first audio signal 715 of a third participant device 100-3, and a first audio signal 717 of the n-th participant device 100-n.

In operation S702, the audio analyzer 231a may analyze a feature point. The audio analyzer 231a may analyze a feature point of the first audio signal of the n-th participant device 100-n among the N participant devices 100. In this example, the feature point may be a sound waveform. Further, n may be “1” in a case of the first audio signal of the first participant device 100-1.

In operation S703, the audio analyzer 231a may estimate a feature value. The audio analyzer 231a may estimate a feature value of the first audio signal of the n-th participant device 100-n among the N participant devices 100. In this example, the feature value may be whether a sound is present. In detail, in operation S703a, the audio analyzer 231a may estimate a section in which a sound is present to be Sₙ(t)=1. In operation S703b, the audio analyzer 231a may estimate a section in which a sound is absent to be Sₙ(t)=0.

The audio analyzer 231a may determine whether the feature value changes. For example, in a case in which Sₙ(t) is “1”, the audio analyzer 231a may initialize FCₙ denoting a frame counter that increases when Sₙ(t) is “0” to “0” in operation S704a. By increasing TCₙ denoting a frame counter that increases when Sₙ(t) is “1” in operation S704c, the audio analyzer 231a may verify whether the number of frames of which Sₙ(t) is estimated consecutively to be “1” exceeds P_{T} in operation S704e. Conversely, in a case in which Sₙ(t) is “0”, the audio analyzer 231a may initialize TCₙ to “0” in operation S704b. By increasing FCₙ in operation S704d, the audio analyzer 231a may verify whether the number of frames of which Sₙ(t) is estimated consecutively to be “0” exceeds P_{F} in operation S704f.

Accordingly, the audio analyzer 231a may estimate a smoothed feature value. In a case in which Sₙ(t) is “1” and TCₙ is less than or equal to P_{T} and in a case in which Sₙ(t) is “0” and FCₙ is less than or equal to P_{F}, the audio analyzer 231a may estimate the smoothed feature value to be previous S′ₙ(t−1) in operation S705a. Conversely, in a case in which Sₙ(t) is “1” and TCₙ is greater than P_{T} or in a case in which Sₙ(t) is “0” and FCₙ is greater than P_{F}, the audio analyzer 231a may estimate S′ₙ(t) to be Sₙ(t) in operation S705b or S705c. In an example of FIG. 7C, the audio analyzer 231a may estimate a smoothed feature value 733 of the second participant device 100-2 to be S′ₙ(t)=0 and S′ₙ(t)=1 for respective sections.

The audio analyzer 231a may update a frame counter in a case in which a feature value is equal to a previous feature value. For example, if Sₙ(t) is “1” and 3i(t) is equal to Sₙ(t−1), the audio analyzer 231a may update to TCₙ to TCₙ=TCₙ+1 in operation S704c. If Sₙ(t) is “0” and Sₙ(t) is equal to Sₙ(t−1), the audio analyzer 231a may update FCₙ to FCₙ=FCₙ+1 in operation S704d.

The audio analyzer 231a may compare the frame counter to a threshold. For example, the audio analyzer 231a may determine whether TCₙ is greater than P_{T} in operation S704e. The audio analyzer 231a may determine whether FCₙ is greater than P_{F} in operation S704f.

Accordingly, the audio analyzer 231a may estimate smoothed feature values.

In a case in which TCₙ is greater than P_{T}, the audio analyzer 231a may estimate the smoothed feature values from S′ₙ(t−P_{T}−1) to S′ₙ(t) to be Sₙ(t) in operation S705c. In a case in which TCₙ is less than P_{T}, the audio analyzer 231a may perform operation S705a.

In a case in which FCₙ is greater than P_{F}, the audio analyzer 231a may estimate the smoothed feature values from S′ₙ(t−P_{T}−1) to S′ₙ(t) to be Sₙ(t) in operation S705b. In a case in which FCₙ is less than P_{F}, the audio analyzer 231a may perform operation S705a.

In operation S706, the audio analyzer 231a may determine a time used for smoothing based on a predetermined period. The audio analyzer 231a may verify whether the smoothed feature value passes a predetermined period T, by determining whether a result of dividing the time t used for smoothing by the predetermined period T is “0”.

In operation S707, the audio analyzer 231a may estimate, in a case of (t %T)══0, final feature values based on the smoothed feature values. That is, the audio analyzer 231a may estimate the final feature values at intervals of the predetermined period T. In this example, the final feature values may be a loudness of a sound and a speaking duration of the sound, and final feature values of the plurality of participant devices 100.

In an example, the audio analyzer 231a may estimate speaking durations of sounds for respective sections based on the smoothed feature values of the n-th participant device 100-n among the N participant devices 100. Further, the audio analyzer 231a may estimate a final feature value by summing up the estimated speaking durations of the sounds for the respective sections. In this example, the final feature value may be a feature value sumᵣ{S′ₙ(t)} obtained by summing up the feature values with respect to the speaking durations of the sounds of the n-th participant device 100-n among the N participant devices 100.

In another example, the audio analyzer 231a may estimate loudnesses of sounds for respective sections based on the smoothed feature values of the n-th participant device 100-n among the N participant devices 100. Further, the audio analyzer 231a estimate a final feature value by averaging the estimated loudnesses of the sounds for the respective sections. In this example, the final feature value may be a feature value avgᵣ{Eₙ(t)} obtained by averaging the feature values of the loudnesses of the sounds of the n-th participant device 100-n among the N participant devices 100.

In operation S708, the determiner 233 may determine contributions of the plurality of participant devices 100 to the video conference based on the final feature values. The determiner 233 may add and determine a contribution Cₙ(t) of the n-th participant device 100-n among the N participant devices 100 to the video conference in proportion to sumᵣ{S′ₙ(t)} and avgᵣ{Eₙ(t)}. In an example of FIG. 7D, the determiner 233 may determine a contribution 751 of the first participant device 100-1 to the video conference to be “5”, a contribution 753 of the second participant device 100-2 to the video conference to be “7”, determine a contribution 755 of the third participant device 100-3 to the video conference to be “2”, and determine a contribution 757 of the n-th participant device 100-n to the video conference to be “9”.

In operation S709a, the determiner 233 may compare n to N in a case in which (t %T)══0 is not satisfied. The determiner 233 may compare the ordinal number n of the corresponding participant device to the number N of the participant devices 100.

In a case in which n is less than N, the determiner 233 may update n to n+1=n, in operation S709b. In a case in which the number of the participant devices 100 is “20” and the ordinal number n of the corresponding participant device is “1”, the determiner 233 may update n to n+1=n, and perform operations S702 through S709a with respect to a second participant device. That is, the determiner 233 may iteratively perform operations S702 through S709a until n is greater than or equal to N. Thus, the determiner 233 may determine contributions of all the N participant devices 100 to the video conference.

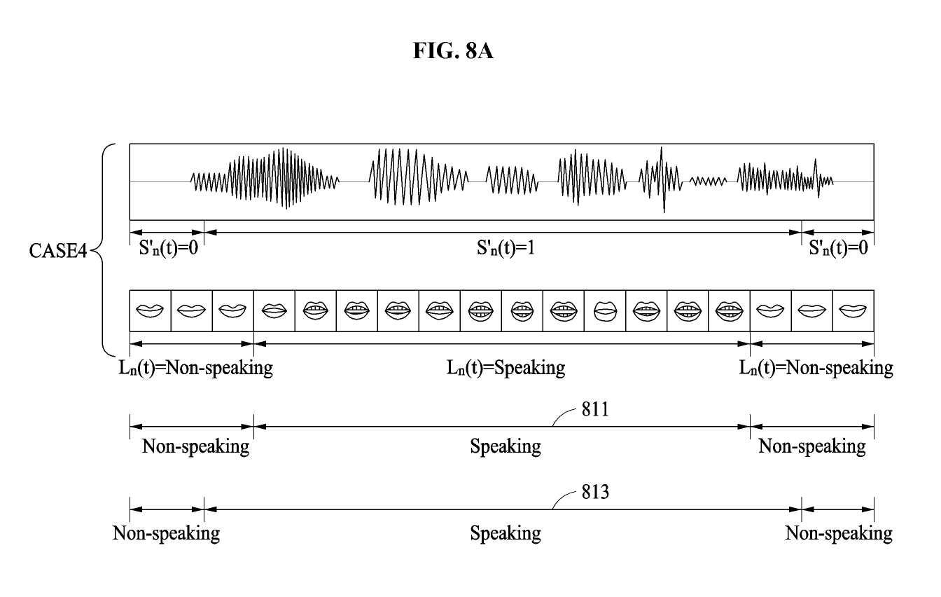

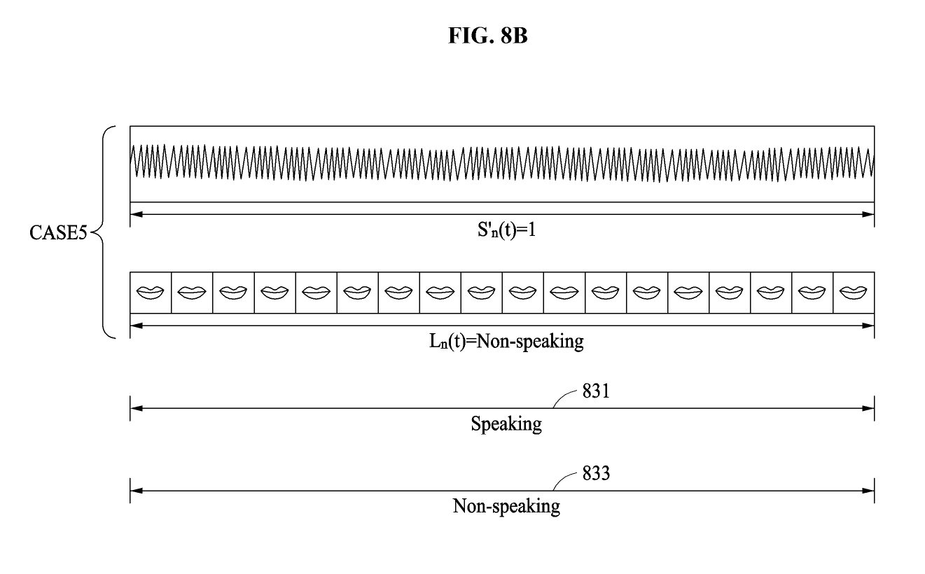

FIG. 8A illustrates an example of the operation of the determiner of FIG. 3.

Referring to FIG. 8A, CASE4 shows a first video signal and a first audio signal including speaking and non-speaking sections.

In CASE4, the determiner 233 may determine whether a participant is speaking based on feature values of the first video signal and the first audio signal through a first speaking determining method 811 and a second speaking determining method 813. In this example, the feature value of the first video signal may be a mouth shape, and the feature value of the first audio signal may be whether a sound is present.

In an example, the determiner 233 may determine whether a participant is speaking through the first speaking determining method 811. In this example, the first speaking determining method 811 may determine a section in which both the first video signal and the first audio signal indicate that the participant is speaking to be a speaking section, and determine a section in which at least one of the first video signal and the first audio signal indicates that the participant is speaking to be a non-speaking section based on the feature values of the first video signal and the first audio signal.

In another example, the determiner 233 may determine whether a participant is speaking through the second speaking determining method 813. In this example, the second speaking determining method 813 may determine a section in which at least one of the first video signal and the first audio signal indicates that the participant is speaking to be a speaking section, and determine a section in which both the first video signal and the first audio signal indicate that the participant is not speaking to be a non-speaking section based on the feature values of the first video signal and the first audio signal.

Thus, the video conference service providing apparatus 200 may determine a contribution to a video conference based on all the feature values of the first video signal and the first audio signal through the first speaking determining method 811.

FIG. 8B illustrates another example of the operation of the determiner of FIG. 3.

Referring to FIG. 8B, CASE5 shows a first audio signal including only a speaking section and a first video signal including only a non-speaking section. In CASE5, the determiner 233 may determine whether a participant is speaking based on feature values of the first video signal and the first audio signal through a third speaking determining method 831 and a fourth speaking determining method 833. In this example, the feature value of the first video signal may be a mouth shape, and the feature value of the first audio signal may be whether a sound is present.

In an example, the determiner 233 may determine whether a participant is speaking through the third speaking determining method 831. In this example, the third speaking determining method 831 may determine a section in which at least one of the first video signal and the first audio signal indicates that the participant is speaking to be a speaking section based on the feature values of the first video signal and the first audio signal.

In another example, the determiner 233 may determine whether a participant is speaking through the fourth speaking determining method 833. In this example, the fourth speaking determining method 833 may determine a section in which at least one of the first video signal and the first audio signal indicates that the participant is not speaking to be a non-speaking section based on the feature values of the first video signal and the first audio signal.

Thus, the video conference service providing apparatus 200 may determine a contribution to a video conference, not including a contribution due to noise, through the fourth speaking determining method 833.

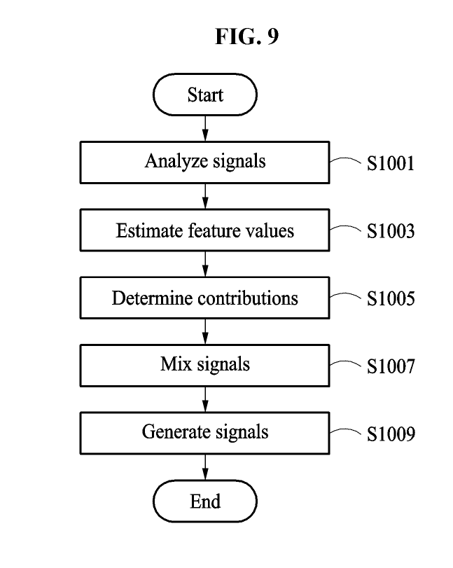

FIG. 9 is a flowchart the video conference service providing apparatus of FIG. 1. Referring to FIG. 9, in operation S1001, the video conference service providing apparatus 200 may analyze feature points of first video signals and first audio signals of the plurality of participant devices 100.

In operation S1003, the video conference service providing apparatus 200 may estimate feature values of the first video signals and the first audio signals based on the analysis on the feature points of the first video signals and the first audio signals. In this example, the video conference service providing apparatus 200 may smooth the estimated feature values of the first video signals and the first audio signals.

In operation S1005, the video conference service providing apparatus 200 may determine contributions of the plurality of participant devices 100 to a video conference based on the feature values of the first video signals and the first audio signals.

In operation S1007, the video conference service providing apparatus 200 may mix the first video signals and the first audio signals of the plurality of participant devices 100 based on the contributions of the plurality of participant devices 100 to the video conference.

In operation S1009, the video conference service providing apparatus 200 may generate a second video signal and a second audio signal by encoding and packetizing the mixed first video signals and first audio signals of the plurality of participant devices 100.

The components described in the exemplary embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include plurality of processing elements and plurality of types of processing elements. For example, a processing device may include plurality of processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments.

For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a video conference service, the method comprising:
determining contributions of a plurality of participants to a video conference based on first video signals and first audio signals of devices of the plurality of participants participating in the video conference; and
generating a second video signal and a second audio signal to be transmitted to the devices of the plurality of participants based on the contributions.

2. The method of claim 1, wherein the determining comprises:
analyzing the first video signals and the first audio signals;
estimating feature values of the first video signals and the first audio signals; and
determining the distributions based on the feature values.

3. The method of claim 2, wherein the analyzing comprises extracting and decoding bitstreams of the first video signals and the first audio signals.

4. The method of claim 2, wherein the feature values of the first video signals include at least one of the number of faces, sizes of the faces, positions of the faces, gazes of the faces, and mouth shapes of the faces.

5. The method of claim 2, wherein the feature values of the first audio signals include at least one of whether a sound is present, a loudness of the sound, and a duration of the sound.

6. The method of claim 1, wherein the generating comprises generating the second video signal and the second audio signal by mixing the first video signals and the first audio signals.

7. The method of claim 6, wherein the generating further comprises determining at least one of a mixing quality and a mixing scheme with respect to the first video signals and the first audio signals based on the contributions.

8. The method of claim 7, wherein the mixing scheme with respect to the first video signals controls at least one of an image arrangement order and an image arrangement size.

9. The method of claim 7, wherein the mixing scheme with respect to the first audio signals controls at least one of whether to block a sound and a volume level.

10. The method of claim 6, wherein the generating further comprises encoding and packetizing the second video signal and the second audio signal.

11. An apparatus for providing a video conference service, the apparatus comprising:
a transceiver configured to receive first video signals and first audio signals of devices of a plurality of participants participating in a video conference; and
a controller configured to determine contributions of the plurality of participants to the video conference based on the first video signals and the first audio signals, and generate a second video signal and a second audio signal to be transmitted to the devices of the plurality of participants based on the contributions.

12. The apparatus of claim 11, wherein the controller comprises:
an analyzer configured to analyze the first video signals and the first audio signals, and estimate feature values of the first video signals and the first audio signals; and
a determiner configured to determine the distributions based on the feature values.

13. The apparatus of claim 12, wherein the analyzer is configured to extract and decode bitstreams of the first video signals and the first audio signals.

14. The apparatus of claim 12, wherein the feature values of the first video signals include at least one of the number of faces, sizes of the faces, positions of the faces, gazes of the faces, and mouth shapes of the faces.

15. The apparatus of claim 12, wherein the feature values of the first audio signals include at least one of whether a sound is present, a loudness of the sound, and a duration of the sound.

16. The apparatus of claim 12, wherein the controller further comprises:
a mixer configured to mix the first video signals and the second video signals; and
a generator configured to generate the second video signal and the second audio signal.

17. The apparatus of claim 16, wherein the mixer is configured to determine at least one of a mixing quality and a mixing scheme with respect to the first video signals and the first audio signals based on the contributions.

18. The apparatus of claim 17, wherein the mixing scheme with respect to the first video signals controls at least one of an image arrangement order and an image arrangement size.

19. The apparatus of claim 17, wherein the mixing scheme with respect to the first audio signals controls at least one of whether to block a sound and a volume level.

20. The apparatus of claim 16, wherein the generator is configured to encode and packetize the second video signal and the second audio signal.
